(19) United States
(12) Patent Application Publication
(10) Pub. No.: US 2024/0313468 A1
(43) Pub. Date: Sep. 19, 2024

(54) WIRING HARNESS AND PROTECTOR

(71) Applicant: SUMITOMO WIRING SYSTEMS, LTD., Mie (JP)

(72) Inventor: Naoki HIKOTA, Mie (JP)

(21) Appl. No.: 18/596,228

(22) Filed: Mar. 5, 2024

(30) Foreign Application Priority Data
Mar. 17, 2023 (JP) 2023-043171

(51) Int. Cl. H01R 13/58

(52) U.S. Cl. CPC H01R 13/5812

(57) ABSTRACT

A wiring harness is provided with a connector-equipped wire assembly and a protector. The protector includes a first cover and a second cover. The first cover includes a first rearward extending portion extending in a rearward direction from a first mounting portion and a first curving portion extending to contact outer diameter sides of curved parts of wires. The second cover includes a second rearward extending portion extending in the rearward direction from a second mounting portion to regulate paths together with the first rearward extending portion so that the wires extend in the rearward direction and a second curving portion extending along inner diameter sides of the curved parts of the wires. A first tip part in the first curving portion includes engaged grooves. A second tip part in the second curving portion includes engaging protrusion to be engaged with the engaged grooves.

### CROSS-REFERENCE TO RELATED APPLICATIONS

This application is based on and claims priority from Japanese Patent Application No. 2023-043171, filed on Mar. 17, 2023, with the Japan Patent Office, the disclosure of which is incorporated herein in its entirety by reference.

### TECHNICAL FIELD

The present disclosure relates to a wiring harness and a protector.

### BACKGROUND

Conventionally, a wiring harness provided with a connector-equipped wire assembly and a protector is known (see, for example, Japanese Patent Laid-open Publication No. 2015-210966). The connector-equipped wire assembly includes a connector and a wire drawn out in a rearward direction from the connector. The protector includes a mounting portion to be mounted on the connector and a curving portion for curving the wire in a pull-out direction different from the rearward direction by contacting the wire. The protector can suppress sudden bending of the wire behind the connector.

### SUMMARY

In the wiring harness as described above, since a large space is present between a rear end part of the connector and the protector, the wire has been allowed to extend in a direction oblique to the rearward direction from the rear end part of the connector. Thus, a large force may be applied from the wire to the rear end part of the connector such as when the wire is a thick wire for high voltage. This causes, for example, the deformation of a water stop rubber interposed between a connector housing of the connector and the wire and, consequently, the deterioration of water stop performance of the connector.

The present disclosure aims to provide a wiring harness and a protector capable of suppressing the application of a large force from a wire to a rear end part of a connector.

The present disclosure is directed to a wiring harness with a connector-equipped wire assembly including a connector and a wire drawn out in a rearward direction from the connector, and a protector including a mounting portion to be mounted on the connector and a curving portion for curving the wire in a pull-out direction different from the rearward direction by contacting the wire, the protector including a first cover and a second cover, the first cover including a first mounting portion constituting a part of the mounting portion, a first rearward extending portion extending in the rearward direction from the first mounting portion and a first curving portion constituting a part of the curving portion by extending from the first rearward extending portion to contact an outer diameter side of a curved part of the wire, the second cover including a second mounting portion constituting a part of the mounting portion, a second rearward extending portion extending in the rearward direction from the second mounting portion to regulate a path for the wire together with the first rearward extending portion so that the wire extends in the rearward direction from the connector, and a second curving portion constituting a part of the curving portion by extending from the second rearward extending portion along an inner diameter side of the curved part of the wire, a first tip part in the first curving portion including an engaged portion, and a second tip part in the second curving portion including an engaging portion for suppressing deformation of the first tip part in the rearward direction by being engaged with the engaged portion.

According to the wiring harness and the protector of the present disclosure, it is possible to suppress the application of a large force from the wire to a rear end part of the connector.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a wiring harness in one embodiment.

FIG. 2 is an exploded perspective view of the wiring harness in the embodiment.

FIG. 3 is a section along 3-3 of FIG. 1.

FIG. 4 is a section along 4-4 of FIG. 1.

FIG. 5 is a partial exploded perspective view of the wiring harness in the embodiment.

FIG. 6 is a section of a wiring harness in another example.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

First, embodiments of the present disclosure are listed and described.

[1] The wiring harness of the present disclosure is provided with a connector-equipped wire assembly including a connector and a wire drawn out in a rearward direction from the connector, and a protector including a mounting portion to be mounted on the connector and a curving portion for curving the wire in a pull-out direction different from the rearward direction by contacting the wire, the protector including a first cover and a second cover, the first cover including a first mounting portion constituting a part of the mounting portion, a first rearward extending portion extending in the rearward direction from the first mounting portion and a first curving portion constituting a part of the curving portion by extending from the first rearward extending portion to contact an outer diameter side of a curved part of the wire, the second cover including a second mounting portion constituting a part of the mounting portion, a second rearward extending portion extending in the rearward direction from the second mounting portion to regulate a path for the wire together with the first rearward extending portion so that the wire extends in the rearward direction from the connector, and a second curving portion constituting a part of the curving portion by extending from the second rearward extending portion along an inner diameter side of the curved part of the wire, a first tip part in the first curving portion including an engaged portion, and a second tip part in the second curving portion including an engaging portion for suppressing deformation of the first tip part in the rearward direction by being engaged with the engaged portion.

According to this configuration, the path for the wire is regulated by the first and second rearward extending portions so that the wire extends in the rearward direction from the connector. Thus, the application of a large force from the wire to a rear end part of the connector can be suppressed. Further, the wire is curved in the pull-out direction different from the rearward direction by the curving portion. In this way, a force acting in the rearward direction is applied from the wire to the first tip part of the first curving portion extending to contact the outer diameter side of the curved part of the wire. However, since the second tip part of the second curving portion includes the engaging portion for suppressing the deformation of the first tip part in the rearward direction by being engaged with the engaged portion of the first tip part, the deformation of the first tip part can be suppressed.

[2] In [1] described above, the engaged portion and the engaging portion may be an engaged groove and an engaging protrusion extending along the pull-out direction.

According to this configuration, since the engaged portion and the engaging portion are the engaged groove and the engaging protrusion extending along the pull-out direction, molding is facilitated and firm engagement is possible, for example, as compared to the case where the engaged portion and the engaging portion are an engaged hole and an engaging claw or the like to be caught by the engaged hole.

[3] In [1] or [2] described above, a plurality of the wires may be arranged in parallel, and the engaged portions and the engaging portions may be provided on both sides in a parallel direction of the wires in the first and second tip parts.

According to this configuration, since the engaged portions and the engaging portions are provided on the both sides in the parallel direction of the wires in the first and second tip parts, the first and second tip parts can be suppressed from being separated and opened on the both sides in the first and second tip parts.

[4] In [3] described above, the engaged portions and the engaging portions may be provided at positions sandwiching the respective wires.

According to this configuration, since the engaged portions and the engaging portions are provided at the positions sandwiching the respective wires, the deformation of the first tip part can be more firmly suppressed, for example, as compared to the case where the engaged portions and the engaging portions are provided only on the both sides in the parallel direction of the wires in the first and second tip parts.

[5] In any one of [1] to [4] described above, the connector may include a connector housing for accommodating an end part of the wire and a water stop rubber interposed between the connector housing and the wire in a rear end part of the connector housing.

According to this configuration, since the connector includes the water stop rubber interposed between the connector housing and the wire in the rear end part of the connector housing, the application of a large force from the wire to the water stop rubber in the rear end part of the connector can be suppressed. Thus, the deformation of the water stop rubber can be suppressed and, consequently, the water stop performance of the connector can be satisfactorily ensured.

[6] In any one of [1] to [5] described above, the protector may include a zip tie, and the zip tie may tie the first rearward extending portion and the wire so that the wire extends in the rearward direction from the connector.

According to this configuration, the first rearward extending portion and the wire are tied by the zip tie so that the wire extends in the rearward direction from the connector. Thus, the wire can be caused to extend in the rearward direction without rattling. Therefore, the application of a large force from the wire to the rear end part of the connector can be satisfactorily suppressed.

[7] In [6] described above, the first cover may include a tie hole, the zip tie being threaded through the tie hole.

According to this configuration, since the first cover includes the tie hole, through which the zip tie is threaded, the first rearward extending portion and the wire can be suitably tied while preventing a position shift of the zip tie.

[8] In [6] or [7] described above, a plurality of the wires may be arranged in parallel, and the zip tie may be provided for each wire.

According to this configuration, since the zip tie is provided for each wire, each wire can be firmly tied to the first rearward extending portion.

[9] In [6] or [7] described above, a plurality of the wires may be arranged in parallel, and one zip tie may be provided for the plurality of wires and the plurality of wires and the first rearward extending portion may be tied by the one zip tie.

According to this configuration, since one zip tie ties the plurality of wires and the first rearward extending portion, the number of components can be reduced, for example, as compared to the case where one zip tie is provided for each wire.

[10] The protector of the present disclosure is provided with a mounting portion to be mounted on a connector in a connector-equipped wire assembly including the connector and a wire drawn out in a rearward direction from the connector, a curving portion for curving the wire in a pull-out direction different from the rearward direction by contacting the wire, and a first cover and a second cover, the first cover including a first mounting portion constituting a part of the mounting portion, a first rearward extending portion extending in the rearward direction from the first mounting portion and a first curving portion constituting a part of the curving portion by extending from the first rearward extending portion to contact an outer diameter side of a curved part of the wire, the second cover including a second mounting portion constituting a part of the mounting portion, a second rearward extending portion extending in the rearward direction from the second mounting portion to regulate a path for the wire together with the first rearward extending portion so that the wire extends in the rearward direction from the connector, and a second curving portion constituting a part of the curving portion by extending from the second rearward extending portion along an inner diameter side of the curved part of the wire, a first tip part in the first curving portion including an engaged portion, and a second tip part in the second curving portion including an engaging portion for suppressing deformation of the first tip part in the rearward direction by being engaged with the engaged portion.

According to this configuration, the path for the wire is regulated by the first and second rearward extending portions so that the wire extends in the rearward direction from the connector. Thus, the application of a large force from the wire to a rear end part of the connector can be suppressed. Further, the wire is curved in the pull-out direction different from the rearward direction by the curving portion. In this way, a force acting in the rearward direction is applied from the wire to the first tip part of the first curving portion extending to contact the outer diameter side of the curved part of the wire. However, since the second tip part of the second curving portion includes the engaging portion for suppressing the deformation of the first tip part in the rearward direction by being engaged with the engaged portion of the first tip part, the deformation of the first tip part can be suppressed.

### DETAILS OF EMBODIMENT OF PRESENT DISCLOSURE

A specific example of a wiring harness 11 of the present disclosure is described below with reference to the drawings. For the convenience of description, some components may be shown in an exaggerated or simplified manner in each drawing. Further, a dimension ratio of each part may be different in each figure. “Parallel,” “orthogonal” and “true circular” in this specification mean not only strictly parallel, orthogonal and true circular, but also substantially parallel, orthogonal and true circular within a range in which functions and effects in this embodiment are achieved. Note that the present invention is not limited to these illustrations, but is represented by claims and intended to include all changes in the scope of claims and in the meaning and scope of equivalents.

### (Configuration of Wiring Harness 11)

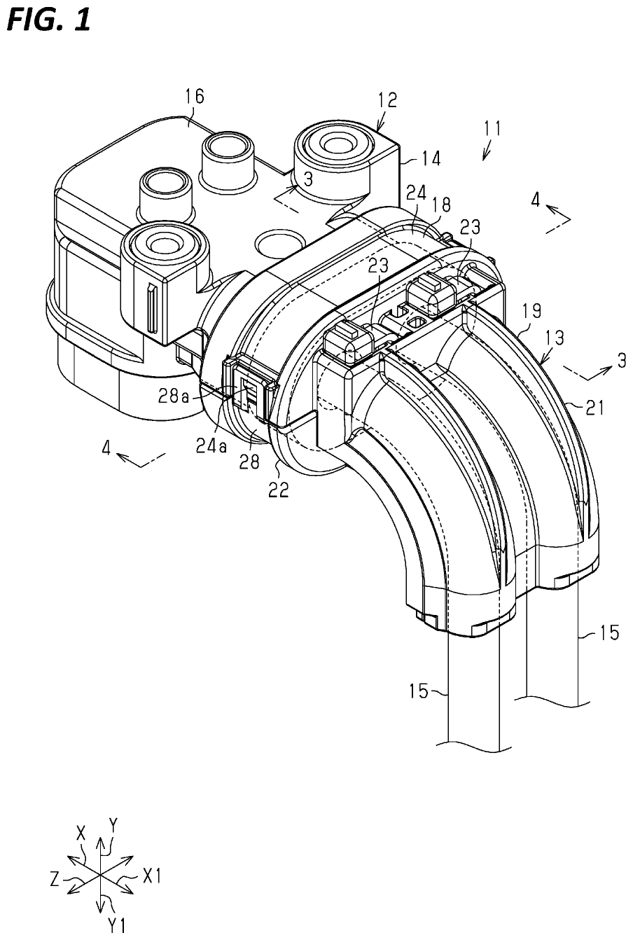

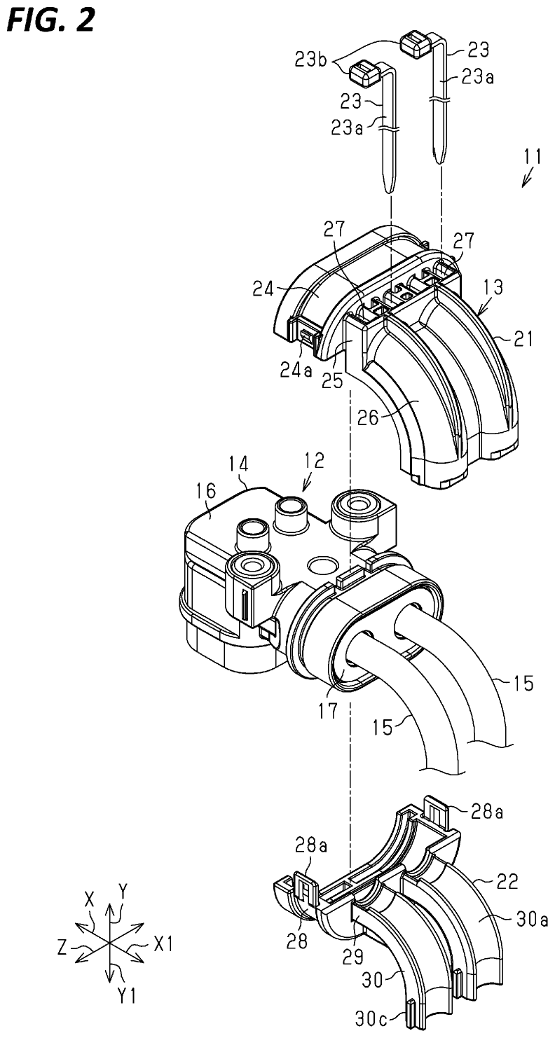

As shown in FIGS. 1 and 2, the wiring harness 11 is provided with a connector-equipped wire assembly 12 and a protector 13. The wiring harness 11 is, for example, a component for high voltage for electrically connecting electrical devices such as an inverter and a high-voltage battery installed in a hybrid vehicle, an electric vehicle or the like. Note that a first axis X, a second axis Y orthogonal to the first axis X and a third axis Z orthogonal to the first and second axes X, Y are shown in figures. Further, a rearward direction X1, which is one of forward and rearward directions along the first axis X, and a pull-out direction Y1, which is one of upward and downward directions along the second axis Y, are shown in figures.

### (Configuration of Connector-Equipped Wire Assembly 12)

As shown in FIGS. 1 and 2, the connector-equipped wire assembly 12 includes a connector 14 and two wires 15 drawn out in the rearward direction X1 from the connector 14.

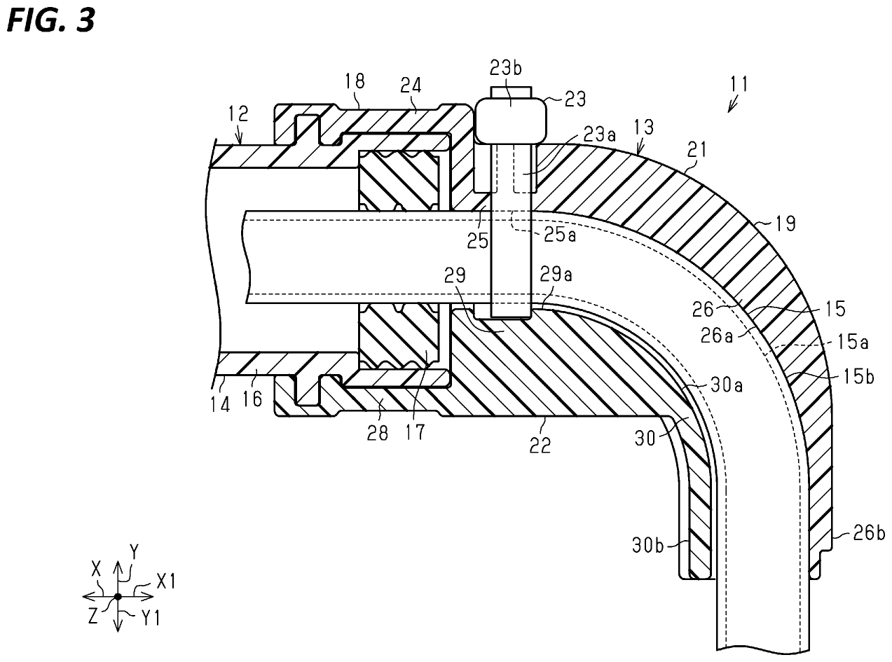

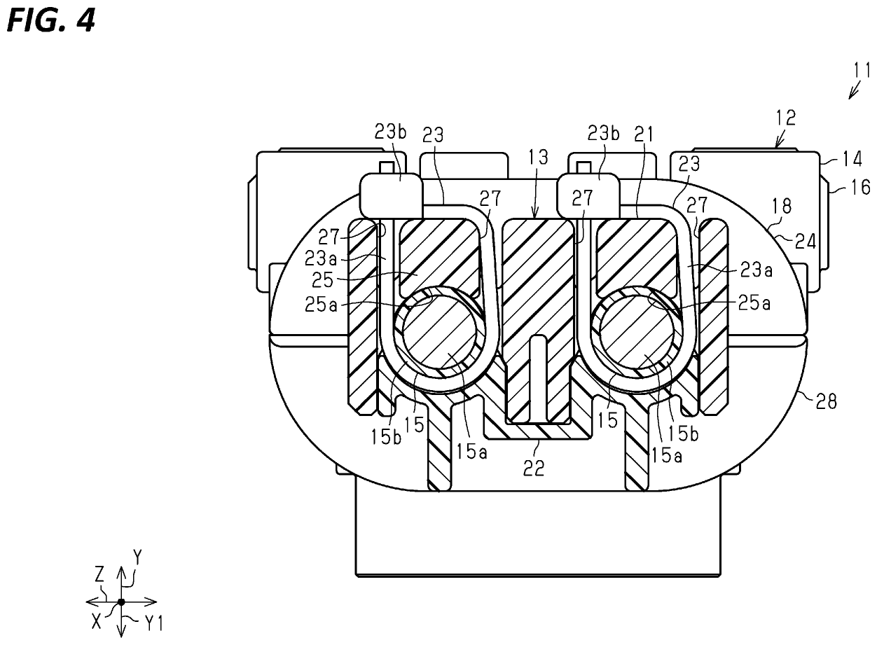

As shown in FIGS. 3 and 4, the wire 15 is a coated wire including a core wire 15a and an insulation coating 15b covering the outer periphery of the core wire 15a. A stranded wire formed by twisting a plurality of metal strands, a single core wire formed of a single conductor and the like can be, for example, used as the core wire 15a. A copper-based or aluminum-based metal material or the like can be, for example, used as a material of the core wire 15a. The insulation coating 15b covers, for example, the outer peripheral surface of the core wire 15a over an entire circumference in a circumferential direction. The insulation coating 15b is made of an insulating resin material. The wire 15 has a circular cross-sectional shape.

As shown in FIG. 3, the connector 14 includes a connector housing 16 and a water stop rubber 17. The connector housing 16 is made of a resin material. The connector housing 16 holds end parts of the two wires 15 while accommodating these end parts. The water stop rubber 17 prevents the intrusion of a liquid into the inside of the connector housing 16 from outside by being interposed between the connector housing 16 and the wires 15 in a rear end part of the connector housing 16. Note that the connector housing 16 also holds unillustrated connection terminals and the like connected to the core wires 15a. The connector 14 is configured to be connectable to an unillustrated external connector, and the connection terminals are connected to terminals of the external connector with the external connector connected.

### (Configuration of Protector 13)

As shown in FIGS. 1 and 3, the protector 13 includes a mounting portion 18 to be mounted on the connector 14 and a curving portion 19 for curving the wires 15 in the pull-out direction Y1 different from the rearward direction X1 by contacting the wires 15.

In particular, as shown in FIGS. 1 to 5, the protector 13 includes a first cover 21, a second cover 22 and zip ties 23. In this embodiment, the zip tie 23 is provided for each wire 15 and the protector 13 includes two zip ties 23.

### (Configuration of First Cover 21)

As shown in FIG. 3, the first cover 21 includes a first mounting portion 24, a first rearward extending portion 25 and a first curving portion 26. The first cover 21 is made of a resin material. The first mounting portion 24 constitutes a part of the mounting portion 18. The first mounting portion 24 is formed to cover a half of the outer periphery of the rear end part of the connector housing 16 and includes locking claws 24a (see FIG. 2) on both circumferential end parts thereof.

The first rearward extending portion 25 extends in the rearward direction X1 from the first mounting portion 24. The first rearward extending portion 25 includes two first rearward extending recesses 25a (see FIG. 4), which are as many as the wires 15. The first rearward extending recess 25a has an arcuate cross-sectional shape.

The first curving portion 26 constitutes a part of the curving portion 19 by extending from the first rearward extending portion 25 to contact outer diameter sides of curved parts of the wires 15. The first curving portion 26 includes two first covering recesses 26a, which are as many as the wires 15. The first covering recess 26a has an arcuate cross-sectional shape. The wires 15 are at least partially accommodated in the first rearward extending recesses 25a and the first covering recesses 26a.

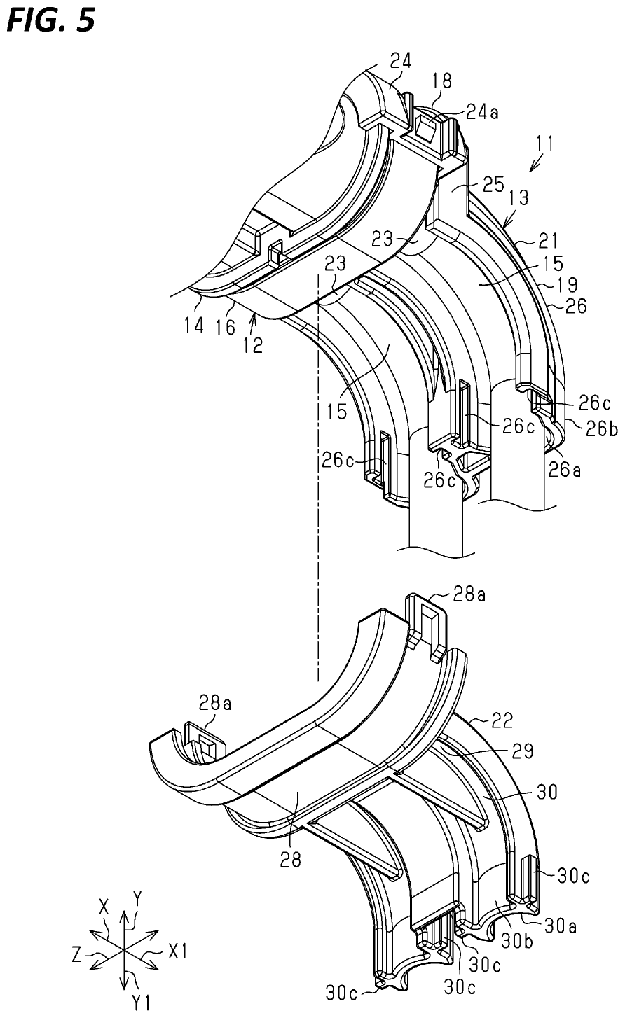

Further, as shown in FIG. 5, a first tip part 26b in the first curving portion 26 includes engaged grooves 26c serving as engaged portions. The engaged groove 26c extends along the pull-out direction Y1 to the tip of the first curving portion 26. The engaged grooves 26c of this embodiment are provided on both sides in a parallel direction (width direction along the third axis Z) of the wires 15 in the first tip part 26b. In particular, the engaged grooves 26c are provided not only on the both sides in the parallel direction (width direction along the third axis Z) of the wires 15, but also at positions sandwiching the respective wires 15. In other words, a pair of the engaged grooves 26c are provided for each first covering recess 26c and for each wire 15, and a total of four engaged grooves 26c are provided in the first tip part 26b.

Further, as shown in FIG. 4, the first cover 21 includes tie holes 27, through which the zip ties 23 are threaded. The tie holes 27 penetrate through the first rearward extending portion 25 in a vertical direction. A pair of the tip holes 27 are provided for each first rearward extending recess 25a and for each wire 15, and a total of four tie holes 27 are provided in the first rearward extending portion 25.

### (Configuration of Second Cover 22)

As shown in FIG. 3, the second cover 22 includes a second mounting portion 28, a second rearward extending portion 29 and a second curving portion 30. The second cover 22 is made of a resin material. The second mounting portion 28 constitutes a part of the mounting portion 18. The second mounting portion 28 is formed to cover a half of the outer periphery of the rear end part of the connector housing 16 and includes locking claws 28a (see FIG. 2) on both circumferential end parts thereof. The locking claws 28a are locked to the locking claws 24a so that the second mounting portion 28 covers the entire periphery of the rear end part of the connector housing 16 together with the first mounting portion 24. In this way, the mounting portion 18 constituted by the first and second mounting portions 24, 28 is mounted on the connector 14 by sandwiching the rear end part of the connector housing 16.

The second rearward extending portion 29 extends in the rearward direction X1 from the second mounting portion 28. The second rearward extending portion 29 includes two second rearward extending recesses 29a, which are as many as the wires 15. The second rearward extending recess 29a has an arcuate cross-sectional shape. The second rearward extending portion 29 regulates paths for the wires 15 together with the first rearward extending portion 25 so that the wires 15 extend in the rearward direction X1 from the connector 14. That is, the first rearward extending recesses 25a of the first rearward extending portion 25 and the second rearward extending recesses 29a of the second rearward extending portion 29 extend in the rearward direction X1 while surrounding the wires 15, thereby regulating the paths for the wires 15 so that the wires 15 extend straight in the rearward direction X1 from the connector 14.

The second curving portion 30 constitutes a part of the curving portion 19 by extending from the second rearward extending portion 29 along inner diameter sides of the curved parts of the wires 15. The second curving portion 30 includes two second covering recesses 30a, which are as many as the wires 15. The second covering recess 30a has an arcuate cross-sectional shape. The wires 15 are at least partially accommodated in the second rearward extending recesses 29a and the second covering recesses 30a. The curving portion 19 constituted by the first and second curving portions 26, 30 curves the wires 15 in the pull-out direction Y1 by contacting the wires 15 to curve the wires 15 while surrounding the wires 15.

Further, as shown in FIG. 5, a second tip part 30b in the second curving portion 30 includes engaging protrusions 30c serving as engaging portions. The engaging protrusion 30c extends along the pull-out direction Y1 to the tip of the second curving portion 30. The engaging protrusions 30c of this embodiment are provided on both sides in the parallel direction (width direction along the third axis Z) of the wires 15 in the second tip part 30b. In particular, the engaging protrusions 30c are provided not only on the both sides in the parallel direction (width direction along the third axis Z) of the wires 15, but also at positions sandwiching the respective wires 15. In other words, a pair of the engaging protrusions 30c are provided for each second covering recess 30c and for each wire 15, and a total of four engaging protrusions 30c are provided in the second tip part 30b. The engaging protrusions 30c are fit into the engaged grooves 26c by relatively moving the second cover 22 upward with respect to the first cover 21. In this way, the engaging protrusions 30c and the engaged grooves 26c are engaged in a front-rear direction. The engaging protrusions 30c suppress the deformation of the first tip part 26b in the rearward direction X1 by being engaged with the engaged grooves 26c. That is, the first tip part 26b may receive a large force in the rearward direction X1 from the curved wires 15, but the deformation of the first tip part 26b in the rearward direction X1 is suppressed by the engagement of the engaging protrusions 30c and the engaged grooves 26c. Further, the first and second tip parts 26b, 30b are suppressed from being separated and opened in the front-rear direction.

### (Configuration of Zip Tie 23)

As shown in FIGS. 3 and 4, the zip tie 23 ties the first rearward extending portion 25 of the first cover 21 and the wire 15 so that the wire 15 extends in the rearward direction X1 from the connector 14. In particular, the zip tie 23 includes a flexible strap-like portion 23a and a lock portion 23b provided on an end part of the strap-like portion 23a in a length direction. The lock portion 23b is for locking the strap-like portion 23a by restricting a movement of the strap-like portion 23a in a withdrawal direction, which is a direction opposite to a threading direction, with the strap-like portion 23 threaded through the lock portion 23b. The zip tie 23 ties the first rearward extending portion 25 and the wire 15 by being threaded through the lock portion 23b with the strap-like portion 23a covering the first rearward extending portion 25 and the wire 15 while being threaded through two tie holes 27. The zip tie 23 is provided for each wire 15 and ties each wire 15 to the first rearward extending portion 25. In this way, the wire 15 is held in close contact with the first rearward extending recess 25a of the first rearward extending portion 25. That is, the wire 15 is interposed between the first rearward extending recess 25a and the second rearward extending recess 29a with a tiny gap formed therebetween, but is positioned to be held in close contact with the first rearward extending recess 25a. In this way, the wire 15 is kept to extend straight in the rearward direction X1 without rattling.

Next, a manufacturing method and functions of the wiring harness 11 configured as described above are described. The manufacturing method of the wiring harness 11 includes a tying step of tying the first rearward extending portion 25 and the wires 15 by the zip ties 23 before the second cover 22 is assembled with the first cover 21 and an assembling step of assembling the second cover 22 with the first cover 21 after the tying step.

As just described, the second cover 22 is easily assembled with the first cover 21 by tying the first rearward extending portion 25 and the wires 15 in advance by the zip ties 23. That is, in a state where the wires 15 are not tied to the first rearward extending portion 25 by the zip ties 23, the wires 15 may be arranged to lift from the first rearward extending recesses 25a of the first cover 21 to become resistance to the assembly of the second cover 22. In contrast, with the wires 15 tied to the first rearward extending portion 25 by the zip ties 23, the wires 15 do not become resistance to the assembly of the second cover 22 since the wires 15 are in contact with the first rearward extending recesses 25a. Thus, the assemblability of the second cover 22 with the first cover 21 is improved. By mounting the protector 13 on the connector-equipped wire assembly 12 in this way, the wires 15 first extend in the rearward direction X1 from the connector 14 and are, thereafter, curved and pulled out in the pull-out direction Y1.

Next, effects of this embodiment are described below.

(1) The paths for the wires 15 are regulated so that the wires 15 extend in the rearward direction X1 from the connector 14 by the first rearward extending portion 25 of the first cover 21 and the second rearward extending portion 29 of the second cover 22. Thus, the application of a large force from the wires 15 to the rear end part of the connector 14 can be suppressed.

Since the connector 14 includes the water stop rubber 17 interposed between the connector housing 16 and the wires 15 in the rear end part of the connector housing 16, the application of a large force from the wires 15 to the water stop rubber 17 in the rear end part of the connector 14 can be suppressed. Thus, the deformation of the water stop rubber 17 can be suppressed and, consequently, the water stop performance of the connector 14 can be satisfactorily ensured.

Further, the wires 15 are curved in the pull-out direction Y1 different from the rearward direction X1 by the curving portion 19. In this way, a force acting in the rearward direction X1 from the wires 15 is applied to the first tip part 26b of the first curving portion 26 extending to contact the outer diameter sides of the curved parts of the wires 15. However, since the second tip part 30b of the second curving portion 30 includes the engaging protrusions 30c for suppressing the deformation of the first tip part 26b in the rearward direction X1 by being engaged with the engaged grooves 26c of the first tip part 26b, the deformation of the first tip part 26b can be suppressed. Further, the first and second tip parts 26b, 30b can be suppressed from being separated and opened in the front-rear direction. Thus, the wires 15 can be, for example, satisfactorily pulled out in the pull-out direction Y1.

(2) Since the engaged grooves 26c and the engaging protrusions 30c extending along the pull-out direction Y1 are adopted as the engaged portions and the engaging portions, molding is facilitated and firm engagement is possible, for example, as compared to the case where the engaged portions and the engaging portions are engaged holes and engaging claws or the like to be caught by the engaged holes.

(3) The engaged grooves 26c and the engaging protrusions 30c are provided on the both sides in the parallel direction (width direction along the third axis Z) of the plurality of wires 15 in the first and second tip parts 26b, 30b. Thus, the first and second tip parts 26b, 30b can be suppressed from being separated and opened on the both sides of the first and second tip parts 26b, 30b.

(4) The engaged grooves 26c and the engaging protrusions 30c are provided not only on the both sides in the parallel direction of the plurality of wires 15, but also at the positions sandwiching the respective wires 15 in the first and second tip parts 26b, 30b. Thus, the deformation of the first tip part 26b can be more firmly suppressed, for example, as compared to the case where the engaged grooves 26c and the engaging protrusions 30c are provided only on the both sides in the parallel direction of the plurality of wires 15 in the first and second tip parts 26b, 30b.

(5) The protector 13 includes the zip ties 23. The first rearward extending portion 25 and the wires 15 are tied by the zip ties 23 so that the wires 15 extend in the rearward direction X1 from the connector 14. Thus, the wires 15 can be caused to extend in the rearward direction X1 from the connector 14 without rattling. Therefore, the application of a large force from the wires 15 to the rear end part of the connector 14 can be satisfactorily suppressed. Further, the vibration of the wires 15 inside the protector 13 can be, for example, suppressed.

(6) Since the first cover 21 includes the tie holes 27, through which the zip ties 23 are threaded, the first rearward extending portion 25 and the wires 15 can be suitably tied while preventing position shifts of the zip ties 23.

(7) Since the zip tie 23 is provided for each wire 15, each wire 15 can be firmly tied to the first rearward extending portion 25.

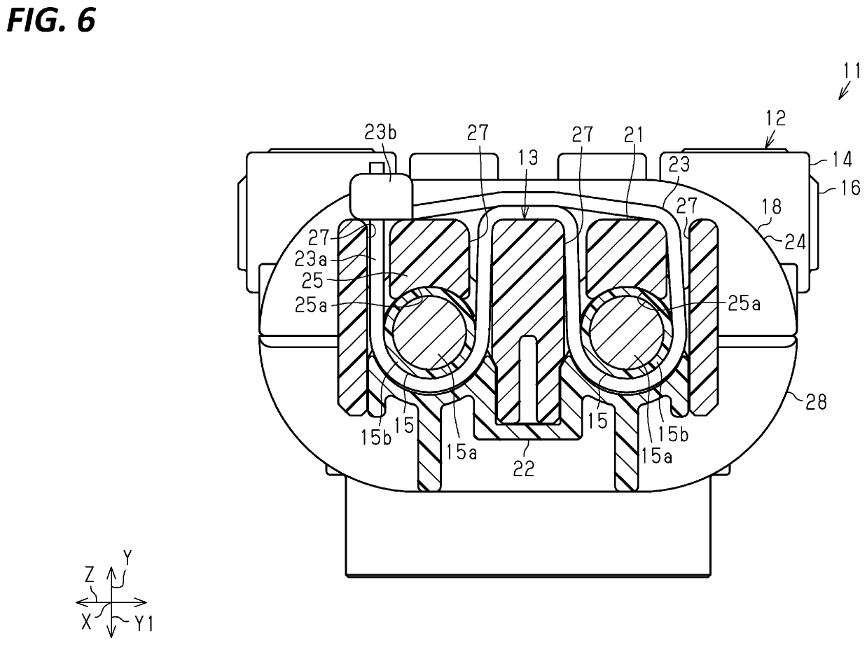

This embodiment can be modified and carried out as follows. This embodiment and the following modifications can be carried out in combination without technically contradicting each other.
Although the zip tie 23 is provided for each wire 15 in the above embodiment, there is no limitation to this and one zip tie 23 may tie the plurality of wires 15 and the first rearward extending portion 25.
For example, as shown in FIG. 6, one zip tie 23 may be provided for two wires 15 and the two wires 15 and the first rearward extending portion 25 may be tied by one zip tie 23. The zip tie 23 of this example ties the first rearward extending portion 25 and the two wires 15 by a strap-like portion 23a being threaded through a lock portion 23b with the strap-like portion 23a covering the first rearward extending portion 25 and the two wires 15 while being threaded through all four tie holes 27. In this way, the number of components can be reduced as compared to the case where the zip tie 23 is provided for each wire 15.
Although the engaged portions and the engaging portions are the engaged grooves 26c and the engaging protrusions 30c extending along the pull-out direction Y1 in the above embodiment, there is no limitation to this and the engaged portions and the engaging portions may be, for example, changed to engaged holes and engaging claws or the like to be caught by the engaged holes. Further, conversely, the engaging portions may be engaging grooves and the engaged portions may be engaged protrusion.
Although the engaged grooves 26c and the engaging protrusions 30c are provided not only on the both sides in the parallel direction of the plurality of wires 15, but also at the positions sandwiching the respective wires 15 in the first and second tip parts 26b, 30b in the above embodiment, there is no limitation to this and the positions and numbers may be changed. For example, the engaged grooves 26c and the engaging protrusions 30c may be provided only on the both sides in the parallel direction of the plurality of wires 15 in the first and second tip parts 26b, 30b. Further, for example, the engaged grooves 26c and the engaging protrusions 30c may be provided only in intermediate parts in the parallel direction of the plurality of wires 15 in the first and second tip parts 26b, 30b.
Although the protector 13 includes the zip ties 23 in the above embodiment, there is no limitation to this and the zip ties 23 may not be included. Note that, of course, the first cover 21 needs not include the tie holes 27 in this case.
Although the first cover 21 includes the tie holes 27, through which the zip ties 23 are threaded, in the above embodiment, there is no limitation to this and the tie holes 27 may not be included. In this case, a zip tie 23 may tie the entire first cover 21 and the wires 15 without being threaded through the tie holes 27.
Although the connector 14 includes the water stop rubber 17 interposed between the connector housing 16 and the wires 15 in the above embodiment, there is no limitation to this and the water stop rubber 17 may not be included. Even with such a configuration, the application of a large force from the wires 15 to the rear end part of the connector 14 can be suppressed, whereby the breakage of the connector housing 16 and the like can be, for example, suppressed.
Although the rearward direction X1 and the pull-out direction Y1, which are extension directions of the wires 15, are orthogonal directions in the above embodiment, there is no limitation to this and the pull-out direction Y1 only has to be a direction different from the rearward direction X1.
Although the connector-equipped wire assembly 12 includes the two wires 15 in the above embodiment, there is no limitation to this and only one wire 15 may be included or three or more wires 15 may be included.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A wiring harness, comprising:
a connector-equipped wire assembly including a connector and a wire drawn out in a rearward direction from the connector; and
a protector including a mounting portion to be mounted on the connector and a curving portion for curving the wire in a pull-out direction different from the rearward direction by contacting the wire,
the protector including a first cover and a second cover,
the first cover including a first mounting portion constituting a part of the mounting portion, a first rearward extending portion extending in the rearward direction from the first mounting portion and a first curving portion constituting a part of the curving portion by extending from the first rearward extending portion to contact an outer diameter side of a curved part of the wire,
the second cover including a second mounting portion constituting a part of the mounting portion, a second rearward extending portion extending in the rearward direction from the second mounting portion to regulate a path for the wire together with the first rearward extending portion so that the wire extends in the rearward direction from the connector, and a second curving portion constituting a part of the curving portion by extending from the second rearward extending portion along an inner diameter side of the curved part of the wire,
a first tip part in the first curving portion including an engaged portion, and
a second tip part in the second curving portion including an engaging portion for suppressing deformation of the first tip part in the rearward direction by being engaged with the engaged portion.

2. The wiring harness of claim 1, wherein the engaged portion and the engaging portion are an engaged groove and an engaging protrusion extending along the pull-out direction.

3. The wiring harness of claim 1, wherein:
a plurality of the wires are arranged in parallel, and
the engaged portions and the engaging portions are provided on both sides in a parallel direction of the wires in the first and second tip parts.

4. The wiring harness of claim 3, wherein the engaged portions and the engaging portions are provided at positions sandwiching the respective wires.

5. The wiring harness of claim 1, wherein the connector includes a connector housing for accommodating an end part of the wire and a water stop rubber interposed between the connector housing and the wire in a rear end part of the connector housing.

6. The wiring harness of claim 1, wherein:
the protector includes a zip tie, and
the zip tie ties the first rearward extending portion and the wire so that the wire extends in the rearward direction from the connector.

7. The wiring harness of claim 6, wherein the first cover includes a tie hole, the zip tie being threaded through the tie hole.

8. The wiring harness of claim 6, wherein:
a plurality of the wires are arranged in parallel, and
the zip tie is provided for each wire.

9. The wiring harness of claim 6, wherein:
a plurality of the wires are arranged in parallel, and
one zip tie is provided for the plurality of wires and the plurality of wires and the first rearward extending portion are tied by the one zip tie.

10. A protector, comprising:
a mounting portion to be mounted on a connector in a connector-equipped wire assembly including the connector and a wire drawn out in a rearward direction from the connector;
a curving portion for curving the wire in a pull-out direction different from the rearward direction by contacting the wire; and
a first cover and a second cover,
the first cover including a first mounting portion constituting a part of the mounting portion, a first rearward extending portion extending in the rearward direction from the first mounting portion and a first curving portion constituting a part of the curving portion by extending from the first rearward extending portion to contact an outer diameter side of a curved part of the wire,
the second cover including a second mounting portion constituting a part of the mounting portion, a second rearward extending portion extending in the rearward direction from the second mounting portion to regulate a path for the wire together with the first rearward extending portion so that the wire extends in the rearward direction from the connector, and a second curving portion constituting a part of the curving portion by extending from the second rearward extending portion along an inner diameter side of the curved part of the wire,
a first tip part in the first curving portion including an engaged portion, and
a second tip part in the second curving portion including an engaging portion for suppressing deformation of the first tip part in the rearward direction by being engaged with the engaged portion.
